(19) United States
(12) Patent Application Publication
(10) Pub. No.: US 2024/0403692 A1
(43) Pub. Date: Dec. 5, 2024

(54) ANOMALY DETECTION

(71) Applicant: ServiceNow, Inc., Santa Clara, CA (US)

(72) Inventors: Lorne Schell, Montreal (CA); Fanny C. Riols, Montreal (CA); Pegah Kamousi, Montreal (CA); Elena Busila, Brossard (CA)

(21) Appl. No.: 18/203,548

(22) Filed: May 30, 2023

(51) Int. Cl. G06N 20/00

(52) U.S. Cl. CPC G06N 20/00

(57) ABSTRACT

A training dataset for anomaly detection is received. An unsupervised machine learning model is trained using at least a portion of the training dataset to generate a trained unsupervised machine learning model. A supervised machine learning model is trained using an output from the unsupervised machine learning model and an anomaly detection feedback associated with the output from the unsupervised machine learning model to generate a trained supervised machine learning model. Both the trained unsupervised machine learning model and the trained supervised machine learning model are provided for combined use in machine learning anomaly detection inference.

### BACKGROUND OF THE INVENTION

Anomaly detection can be used to detect events that fall outside a normal trend. The detected deviation or outlier incident can be an indicator that an error, failure, defect, or suspicious event has occurred. When an anomaly has been detected, typically an operations team is notified of the incident and may be assigned to investigate and address the underlying cause. Common uses for anomaly detection include data cleaning, intrusion detection, fraud detection, system health monitoring, and ecosystem disturbances.

### BRIEF DESCRIPTION OF THE DRAWINGS

Various embodiments of the invention are disclosed in the following detailed description and the accompanying drawings.

FIG. 1 is a block diagram illustrating an example of a network environment for performing improved anomaly detection.

FIG. 2 is a block diagram illustrating an embodiment for implementing an anomaly detection service.

FIG. 3 is a flow chart illustrating an embodiment of a process for improving anomaly detection by combining an unsupervised machine learning model with a supervised machine learning model.

FIG. 4 is a flow chart illustrating an embodiment of a process for configuring and training an unsupervised machine learning anomaly detector.

FIG. 5 is a flow chart illustrating an embodiment of a process for detecting an anomaly using a combined unsupervised machine learning model and a supervised machine learning model.

FIG. 6 is a flow chart illustrating an embodiment of a process for providing anomaly detection results using a combined unsupervised machine learning model and a supervised machine learning model.

FIG. 7 is a flow chart illustrating an embodiment of a process for initiating the retraining of a machine learning model.

FIG. 8 is a functional diagram illustrating a programmed computer system for improving anomaly detection.

FIG. 9 is a diagram illustrating an embodiment of a user interface of an anomaly detection service for collecting user feedback to improve anomaly detection.

FIG. 10 is a diagram illustrating an embodiment of a user interface of an anomaly detection service for collecting additional user feedback to improve anomaly detection.

FIG. 11 is a diagram illustrating an embodiment of a conversion scale used to transform an exponential maturity score to a linear maturity score.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Improved anomaly detection is disclosed. For example, a supervised machine learning model is trained with optional user feedback provided on anomaly prediction results. The initial anomaly results are predicted using a trained unsupervised machine learning model. Once the supervised machine learning model is trained, the anomaly prediction results of the trained unsupervised machine learning model are fed as inputs to the supervised machine learning model to determine anomaly prediction results with improved accuracy over using the unsupervised machine learning model alone. In some embodiments, the supervised machine learning model is a supervised machine learning anomaly classifier that classifies the anomaly prediction results of the trained unsupervised machine learning model.

In various embodiments, a maturity associated with the trained supervised model (or combined unsupervised and supervised models) is determined and presented to users. For example, as part of an interactive user interface for receiving user feedback, the maturity of the supervised model (or the combined models) is provided. As additional feedback is provided, the accuracy of the supervised machine learning improves, and the maturity correspondingly increases. In some embodiments, the maturity is presented as a maturity score and/or as the change in improvement due to recent provided feedback. In various embodiments, the supervised machine learning model is retrained more frequently than the unsupervised machine learning model resulting in a maturity evaluation that reflects recently provided feedback. In some embodiments, the maturity can be presented as a linear value converted from a logarithmic value, such as one calculated using a logarithmic-based loss function.

In some embodiments, a training dataset for anomaly detection is identified and received. For example, training data is identified for use in training a machine learning model. The identified training data is provided to and received by a machine learning training platform for training a model for predicting anomalies. The training data can include metrics collected by monitoring an information technology (IT) infrastructure such as a network computing environment including the network and individual devices of the network computing environment. In some embodiments, the training data is profiled, for example, to remove constant values, and preprocessed. Example features associated with the training data can include network utilization, number of incoming packets per second, number of outgoing packets per second, device CPU speed, device CPU temperature, device memory usage, and device swap size, among others.

In some embodiments, an unsupervised machine learning model is trained using at least a portion of the training dataset, to generate a trained unsupervised machine learning model. For example, the identified and received training dataset is used to train a machine learning model using unsupervised training to predict anomalies. In particular use cases, the number of features utilized for training and prediction is so numerous that supervised training is tedious and/or not reasonably practical. In some embodiments, a supervised machine learning model is trained using an output from the unsupervised machine learning model and an anomaly detection feedback associated with the output from the unsupervised machine learning model, to generate a trained supervised machine learning model. For example, users can provide feedback on whether a predicted anomaly is an actual anomaly or a false positive. In particular embodiments, the user can also provide feedback on what features contributed or should not have contributed to the prediction result. For example, a user can indicate that a predicted anomaly associated with a detected CPU spike at midnight is a false positive and that the associated CPU utilization should not have influenced the prediction outcome.

In some embodiments, both the trained unsupervised machine learning model and the trained supervised machine learning model are provided for combined use in machine learning anomaly detection inference. For example, by using both the unsupervised and supervised machine learning models together, anomalies are predicted with a higher accuracy than by using only the unsupervised machine learning model alone for prediction. For example, the output of the unsupervised model is fed as input to the supervised model to predict anomalies. In some embodiments, the input provided to the unsupervised machine learning model is further reconstructed and used as input to the supervised machine learning model.

In some embodiments, an indication of a maturity of the supervised machine learning model is determined and provided. For example, to incentivize users to provide feedback on machine learning prediction results, feedback on the maturity and the change in maturity of the supervised machine learning model and/or the combined unsupervised and supervised models is provided. In some embodiments, the maturity is presented as a maturity score that can increase as additional feedback is provided and as the prediction results improve. The maturity can be calculated using one or more loss calculations. In some embodiments, the maturity score can be based on loss calculation results for three or more epochs associated with the supervised machine learning model. For example, a running average of loss calculation results from past epochs can be calculated and used to determine the maturity of the prediction model or models. In some embodiments, the maturity can be determined by converting a logarithmic value, such as a logarithmic loss calculation result, to a linear value.

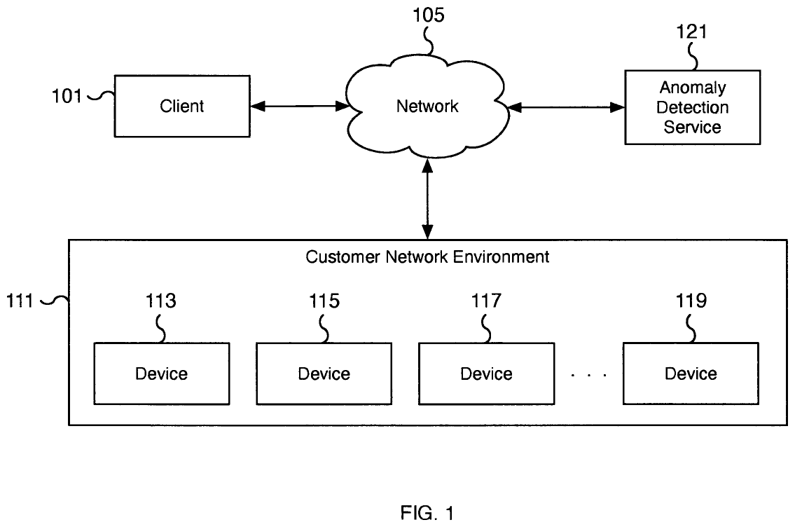

FIG. 1 is a block diagram illustrating an example of a network environment for performing improved anomaly detection. In the example shown, client 101 and anomaly detection service 121 are connected via network 105. Network 105 can be a public or private network. In some embodiments, network 105 is a public network such as the Internet. In various embodiments, anomaly detection service 121 corresponds to a cloud-based application server that provides a service for predicting anomalies, such as anomalies within an information technology (IT) infrastructure such as customer network environment 111. For example, customer network environment 111 is monitored and metrics related to customer network environment 111 and its devices are provided to anomaly detection service 121 where machine learning prediction models are used to predict anomalies. In some embodiments, the predicted anomalies are displayed in an interactive user interface dashboard provided by anomaly detection service 121 and accessible from clients such as client 101. Users can provide feedback on predicted anomalies including whether a predicted anomaly is a true anomaly or a false positive. Based on the provided feedback, accuracy of the anomaly detection service provided by anomaly detection service 121 is improved. In the example shown, example devices of customer network environment 111 include devices 113, 115, 117, and 119.

In some embodiments, client 101 is an example client for accessing anomaly detection service 121. Client 101 is a network device such as a desktop computer, a laptop, a mobile device, a tablet, a kiosk, a voice assistant, a wearable device, or another network computing device. As a network device, client 101 can access cloud-based services including anomaly detection service 121. For example, a member of the information technology service management (ITSM) team can utilize a web browser or similar application from client 101 to receive notifications of a predicted anomaly, to review predicted anomalies (such as via an interactive dashboard), to view the performance of the anomaly detection service provided by anomaly detection service 121, and/or to provide feedback on anomaly detection service 121. Although shown in FIG. 1 as located outside of customer network environment 111, client 101 can also be located within customer network environment 111.

In some embodiments, anomaly detection service 121 offers a cloud-based anomaly detection service for predicting anomalies such as those occurring within an IT infrastructure such as customer network environment 111. In various embodiments, the anomalies are predicted by performing an inference process using metrics collected on an environment such as by monitoring customer network environment 111 and its devices. Example metrics that can be collected and applied as input features for prediction include but are not limited to metrics related to network utilization, the number of incoming packets per second, the number of outgoing packets per second, device CPU speeds, device CPU temperatures, device memory usages, device swap sizes, and the number of running processes, among others. In various embodiments, anomaly detection service 121 utilizes both trained unsupervised and supervised machine learning models. For example, the initial anomaly prediction outputs are based on the prediction results of a trained unsupervised machine learning model. Based on user feedback provided on the initial anomaly prediction results, a supervised machine learning model is trained. The output of the trained unsupervised machine learning model is then provided as an input to the trained supervised machine learning model. The output of the trained supervised machine learning model is then used for anomaly prediction results. In some embodiments, the initial prediction results pass through the supervised machine learning model without modification until sufficient user feedback is received to retrain the supervised model and to improve anomaly detection results. In some embodiments, the trained supervised machine learning model is an anomaly classifier that classifies the output results of the trained unsupervised machine learning model.

In some embodiments, anomaly detection service 121 further provides an interactive user interface dashboard for displaying anomaly detection results and for collecting user feedback on predicted anomalies. For example, the provided dashboard can display a predicted anomaly and the features (or metrics) that influenced the predicted anomaly. In some embodiments, the top impacting features are displayed along with their contribution (such as a percentage value) to a predicted anomaly. In various embodiments, the prediction results are displayed along with the maturity of the anomaly detection models. For example, the more mature the anomaly detection models, the more accurate the prediction results. As more user feedback is provided, the accuracy of the models will improve along with their maturity. In some embodiments, the maturity corresponds to the maturity of the trained supervised machine learning model, the trained unsupervised machine learning model, and/or the combination of the trained unsupervised and supervised machine learning models. In some embodiments, the maturity is presented as one or more scores such as a maturity score and a feedback score. For example, the maturity score can correspond to a loss metric calculated on the models (or a model) and a feedback score can be a difference in loss metrics between different model versions. By providing a feedback score based on a difference between scores, users are provided with a quantified assessment on how much the anomaly detection has improved based on their provided feedback. In some embodiments, the maturity score is initially determined as a result that is based on a logarithmic scale which is then converted to and presented as a linear value. In particular embodiments, the provided linear value is more easily understood by users than a logarithmic value and significantly improves user engagement in providing feedback on anomaly results resulting in a more accurate supervised machine learning model.

In various embodiments, the supervised machine learning model is retrained more frequently or more often than the unsupervised machine learning model. For example, the supervised machine learning model is trained at a training rate that is greater than the training rate at which the unsupervised machine learning model is trained. By retraining the supervised machine learning model and updating the presented maturity and feedback scores, users are incentivized to become more actively engaged in the process of providing feedback. In various embodiments, the user feedback is collected by anomaly detection service 121 via a user interface that allows the user to easily select whether a predicted anomaly is a true positive or a false positive and to further specify the relative impact of features on the predicted anomaly. The received user feedback is then used as training data to retrain the supervised machine learning model.

In some embodiments, customer network environment 111 is an information technology network environment and includes multiple hardware devices including devices 113, 115, 117, and 119, as examples. Devices 113, 115, 117, and 119 correspond to hardware devices that are managed by an ITSM group and each device can be one of a variety of different hardware device types including networking equipment (such as gateways and firewalls), load balancers, servers including application servers and database servers among other servers, and other computing devices including employee laptops and desktops. For example, in one scenario, devices 113, 115, 117, and 119 are each servers and one of the servers may have a hardware failure that triggers a predicted anomaly as detected by anomaly detection service 121. In various embodiments, customer network environment 111 is connected to network 105. In various embodiments, the topology of customer network environment 111 can differ and the topology shown in FIG. 1 is just one simplified example.

Although single instances of some components have been shown to simplify the diagram of FIG. 1, additional instances of any of the components shown in FIG. 1 may exist. For example, anomaly detection service 121 may be implemented using one or more servers such as one or more distributed application servers. In some embodiments, the implementation of anomaly detection service 121 further utilizes one or more databases. Different network topologies for implementing anomaly detection service 121 are appropriate and the servers and/or databases utilized by anomaly detection service 121 may be replicated and/or distributed across multiple servers, databases, and/or related components. Additionally, client 101 is an example client device for interfacing with anomaly detection service 121. Although a single client is shown (i.e., client 101), many more additional clients can exist and can be used to interface with anomaly detection service 121. As mentioned above, customer network environment 111 is just one example of a network environment of devices monitored for anomalies by anomaly detection service 121. For example, in various embodiments, anomaly detection service 121 can manage additional network environments not shown including different distributed environments and different sub-networks. In some embodiments, components not shown in FIG. 1 may also exist.

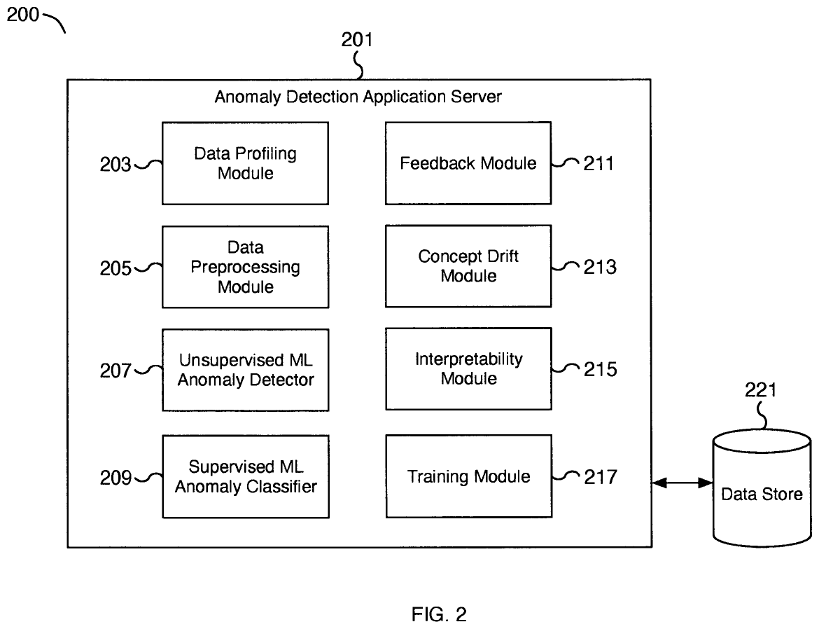

FIG. 2 is a block diagram illustrating an embodiment for implementing an anomaly detection service. In the example shown, anomaly detection service 200 includes anomaly detection application server 201 and data store 221. In various embodiments, the shown components of anomaly detection application server 201 and data store 221 are used to implement an anomaly detection service for predicting anomalies. For example, anomaly detection application server 201 using data store 221 implements the functionality for training and predicting anomalies for an IT infrastructure. In some embodiments, anomaly detection service 200 is anomaly detection service 121 of FIG. 1.

In some embodiments, anomaly detection application server 201 includes multiple modules as shown in FIG. 2 for implementing the different functionality of anomaly detection service 200. As shown in the example, anomaly detection application server 201 includes data profiling module 203, data preprocessing module 205, unsupervised machine learning anomaly detector 207, supervised machine learning anomaly classifier 209, feedback module 211, concept drift module 213, interpretability module 215, and training module 217. Although shown as distinct modules, the functionality of the modules of anomaly detection application server 201 may be implemented in fewer or more modules and/or distributed across different application servers. For example, some of the modules may be combined into a single module and/or some of the modules may be separated, replicated, and/or distributed into or as additional modules, as appropriate. Moreover, although anomaly detection application server 201 is shown as a single server, its functionality can be implemented and/or distributed across multiple servers including multiple distributed servers. For example, unsupervised machine learning anomaly detector 207 can be implemented using one or more machine learning inference servers different from the machine learning inference servers of supervised machine learning anomaly classifier 209. Similarly, one or more machine learning training servers can be used to train unsupervised machine learning anomaly detector 207 and/or the same, different, or a subset of the same servers can be used to train supervised machine learning anomaly classifier 209.

In some embodiments, data profiling module 203 is a processing module for evaluating potential training data to determine whether the data fits the profile of useful training data. For example, potential training data can be evaluated to determine whether the values associated with a particular metric are constant and/or have characteristics associated with useful training data. In various embodiments, metrics with constant (or stationary) values can be excluded by data profiling module 203 from the training dataset. In some embodiments, data profiling module 203 can apply one or more configured filters and/or checks to evaluate a metric to determine whether the metric will be a useful feature to train on. Metrics that meet the profile for useful training data can be passed to data preprocessing module 205.

In some embodiments, data preprocessing module 205 is a processing module for preparing the identified training data for use in training the unsupervised and/or supervised machine learning models. In some embodiments, data preprocessing module 205 will forward fill values for certain features such as in the case of missing values. In some embodiments, data preprocessing module 205 will fill missing older values, for example, with the mean value of the metric or another appropriate value. In various embodiments, the unsupervised machine learning model includes an auto-encoder that learns the provided feature data and data preprocessing module 205 prepares the training data by removing data associated with anomalies allowing the unsupervised machine learning model to be retrained with training data that does not include anomalies. In some embodiments, data preprocessing module 205 prepares the data such that the unsupervised machine learning model can be trained to not only predict anomalies but to also reconstruct the input provided to the unsupervised machine learning model for use as input to the supervised machine learning model.

In some embodiments, data preprocessing module 205 preprocesses user collected feedback including label feedback for training a supervised machine learning model for supervised machine learning anomaly classifier 209. For example, user feedback collected in a natural language can be processed and utilized as label data for supervised training. In some embodiments, the user feedback is processed to prepare training data to train a classifier for classifying anomaly results outputted by unsupervised machine learning anomaly detector 207. The received data for preprocessing can include reconstructed input data received by unsupervised machine learning anomaly detector 207 and used as input data for supervised machine learning anomaly classifier 209.

In some embodiments, unsupervised machine learning anomaly detector 207 is a processing module for performing machine learning inference to detect anomalies using a trained unsupervised machine learning model. The anomalies can be predicted for an IT infrastructure environment based on input feature data collected by monitoring the IT infrastructure environment. In various embodiments, the unsupervised machine learning model is trained using training module 217 on data selected using data profiling module 203 and processed using data preprocessing module 205. In some embodiments, unsupervised machine learning anomaly detector 207 uses one or more machine learning prediction servers and outputs not only predicted anomalies but also a reconstruction of the input it is provided. For example, the reconstructed input can be provided to supervised machine learning anomaly classifier 209 along with prediction results to classify the prediction result. In some embodiments, the unsupervised machine learning model utilized by unsupervised machine learning anomaly detector 207 includes an auto-encoder that learns the provided feature data allowing unsupervised machine learning anomaly detector 207 to reconstruct the input data it is provided.

In some embodiments, supervised machine learning anomaly classifier 209 is a processing module for classifying anomaly prediction results using a supervised machine learning model. For example, using anomaly prediction results from unsupervised machine learning anomaly detector 207, supervised machine learning anomaly classifier 209 can classify the provided anomaly prediction results outputted from the unsupervised model to provide an additional determination layer for evaluating potential anomalies. In some embodiments, supervised machine learning anomaly classifier 209 also receives as input a reconstructed version of the input utilized by unsupervised machine learning anomaly detector 207 to predict the corresponding anomaly prediction result. In various embodiments, in addition to predicting anomaly results with greater accuracy than unsupervised machine learning anomaly detector 207, supervised machine learning anomaly classifier 209 also predicts a severity associated with a detected anomaly. For example, supervised machine learning anomaly classifier 209 can classify a predicted anomaly with a severity score, ranking, or another severity metric. Example severity rankings can include a minor, severe, or critical severity rank.

In some embodiments, supervised machine learning anomaly classifier 209 utilizes an expert sub-model that is trained with user provided feedback or labelling. The supervised machine learning model of supervised machine learning anomaly classifier 209 can be trained quickly in order to incorporate feedback in real time or near real time and to report the impact of the provided user feedback. Compared to the model of unsupervised machine learning anomaly detector 207, supervised machine learning anomaly classifier 209 is trained much more frequently. In some embodiments, the supervised machine learning model of supervised machine learning anomaly classifier 209 is trained using training module 217 on data including user feedback data processed using data preprocessing module 205.

In some embodiments, feedback module 211 is a processing module for collecting user feedback on detected anomalies including predicted anomalies. For example, feedback module 211 can implement an interactive user interface dashboard for presenting detected anomalies and the corresponding user interface components to receiving user feedback including label feedback on the prediction results. Example user feedback can include whether a predicted anomaly is a true positive or a false positive along with feedback on the features used in the prediction. As another example, collected user feedback can include whether an anomaly alert is useful or not useful and the reasons why. In various embodiments, feedback module 211 can also present feature data including data on the metrics used to predict an anomaly and receive corresponding user feedback on what anomalies should or should not have impacted the prediction. In some embodiments, feedback module 211 operates as a notification system which accepts feedback on the notification results. In various embodiments, the feedback collected via feedback module 211 is preprocessed as training data for training supervised machine learning anomaly classifier 209. In some embodiments, the collected feedback data is preprocessed by data preprocessing module 205.

In some embodiments, feedback module 211 provides a maturity associated with the anomaly detection and/or a maturity of the corresponding models used by anomaly detection service 200. For example, a maturity score and/or feedback score of unsupervised machine learning anomaly detector 207 and/or supervised machine learning anomaly classifier 209 can be presented that corresponds to the accuracy of the trained model(s) and the improvement in the anomaly detection given the provided user feedback, respectively. In some embodiments, feedback module 211 presents the maturity score as a linear value after first calculating one or more loss calculation results that are represented on an exponential scale. In various embodiments, feedback module 211 can also present the features that influence the prediction results. For example, the top features that are determined to have resulted in (or influenced) a predicted anomaly are presented, allowing the user to provide feedback on whether the metrics should have been as heavily weighted for determining the prediction result. In various embodiments, the features and their corresponding contributions are determined by interpretability module 215.

In some embodiments, concept drift module 213 is a processing module for evaluating whether the models utilized by anomaly detection service 200 need retraining and/or recalibration. For example, concept drift module 213 can determine whether the model of unsupervised machine learning anomaly detector 207 has drifted sufficiently far away from its configured and/or intended purpose. In some embodiments, the drift is determined by evaluating the reconstruction error of the corresponding trained model and comparing the error to a configured threshold value. In various embodiments, concept drift module 213 can initiate the retraining of a model, for example, by utilizing training module 217 to retrain the unsupervised machine learning model of unsupervised machine learning anomaly detector 207. In some embodiments, concept drift module 213 is also used to evaluate the supervised machine learning model of supervised machine learning anomaly classifier 209 and can initiate the retraining for its associated model.

In some embodiments, interpretability module 215 is a processing module for evaluating prediction anomalies to determine which metrics are most responsible for the prediction result. In some embodiments, interpretability module 215 can determine a contribution associated with the input features including a contribution percentage to attribute to the features. For example, interpretability module 215 can determine the top metrics that influenced a predicted anomaly and present their corresponding contributions as a ranking, a ranked score, and/or a contribution percentage. In various embodiments, the results of interpretability module 215 are provided to the user, for example, via feedback module 211, to initiate user feedback including feedback on the interpreted metric results.

In some embodiments, training module 217 is a processing module for training the machine learning models of anomaly detection service 200 and in particular the models of unsupervised machine learning anomaly detector 207 and supervised machine learning anomaly classifier 209. In some embodiments, training module 217 is implemented as different and/or distinct training modules for unsupervised machine learning anomaly detector 207 and supervised machine learning anomaly classifier 209. For example, the model of unsupervised machine learning anomaly detector 207 can be trained as an unsupervised machine learning model and the model of supervised machine learning anomaly classifier 209 can be trained as a supervised expert sub-model. Moreover, the training frequency and the amount of processing power and/or data required to train each model may be different and require different resources. In various embodiments, the training data for training the respective models is preprocessed and/or prepared by data profiling module 203 and/or data preprocessing module 205. In some embodiments, training module 217 relies on one or more dedicated machine learning training servers.

In some embodiments, data store 221 corresponds to one or more data stores utilized by anomaly detection application server 201 for storing and/or retrieving data for anomaly detection. For example, data store 221 can store model data as well as training data for unsupervised machine learning anomaly detector 207 and/or supervised machine learning anomaly classifier 209. In some embodiments, data store 221 is used to store user feedback collected via feedback module 211 and/or the configuration and/or results for the various modules of anomaly detection application server 201 including data profiling module 203, data preprocessing module 205, unsupervised machine learning anomaly detector 207, supervised machine learning anomaly classifier 209, feedback module 211, concept drift module 213, interpretability module 215, and/or training module 217. In some embodiments, data store 221 is implemented as one or more distributed and/or replicated data stores or databases. For example, one or more portions of data store 221 may be located at a different physical location (such as in a different data center) than anomaly detection application server 201. In various embodiments, data store 221 is communicatively connected to anomaly detection application server 201 via one or more network connections.

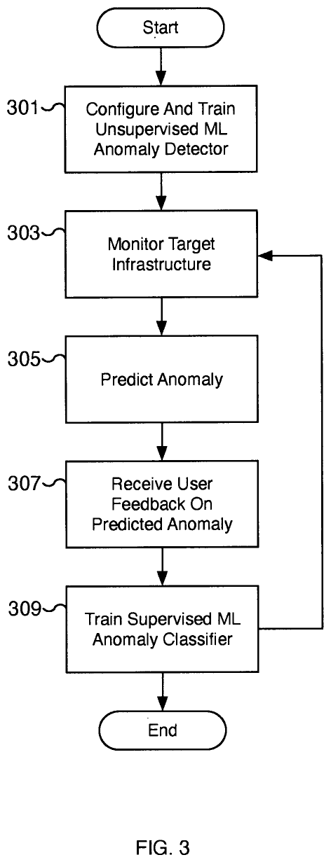

FIG. 3 is a flow chart illustrating an embodiment of a process for improving anomaly detection by combining an unsupervised machine learning model with a supervised machine learning model. For example, using the process of FIG. 3, an anomaly detection service detects anomalies, such as within an IT infrastructure environment, based on provided input data. The provided input data can be metrics collected by monitoring the target environment. In various embodiments, the anomaly detection service utilizes an unsupervised machine learning model combined with a supervised machine learning model. For example, the output of an unsupervised machine learning anomaly detector is fed to a supervised machine learning anomaly classifier to predict anomalies. Based on provided anomaly results, users can provide feedback that is collected and utilized to train (and subsequently retrain) the supervised machine learning model. In some embodiments, the initial prediction results are based on the untrained machine learning model and once sufficient user feedback is collected, the trained supervised machine learning model is used to classify the output of the untrained machine learning model to produce improved prediction results. In some embodiments, the anomaly detection service is anomaly detection service 121 of FIG. 1 and/or anomaly detection service 200 of FIG. 2, the unsupervised machine learning model is associated with unsupervised machine learning anomaly detector 207 of FIG. 2, and/or the supervised machine learning model is associated with supervised machine learning anomaly classifier 209 of FIG. 2. In some embodiments, the anomaly detection results are provided to and user feedback is collected from a client such as client 101 of FIG. 1. In some embodiments, the anomalies are detected within an IT infrastructure environment such as customer network environment 111 of FIG. 1.

At 301, an unsupervised machine learning anomaly detector is configured and trained. For example, potential training data is identified, profiled, and/or prepared to generate training data for training the unsupervised machine learning model of an unsupervised machine learning anomaly detector. For example, data can be profiled using a data profile module to remove features with constant or stationary values. The remaining feature data can be preprocessed, for example, by a data preprocessing module that completes or fills in missing values. In some embodiments, the input features correspond to metrics collected by monitoring the target environment and its devices. Example features can include network utilization, number of incoming packets per second, number of outgoing packets per second, device CPU speed, device CPU temperature, device memory usage, and device swap size, among others. In various embodiments, the number of input features can range from a small number of features to dozens of, hundreds of, or more features. In particular embodiments, the number of input features exceeds the number that is reasonably manageable via supervised training.

At 303, a target infrastructure is monitored. For example, a target IT environment such as a customer network environment is monitored for operating conditions such as operating and/or configuration metrics. The collected metrics are collected for use as potential input features to the anomaly detection service and its corresponding machine learning models to infer prediction results. The collected metrics correspond to the metrics utilized for training the model at 301. Example features can include network utilization, number of incoming packets per second, number of outgoing packets per second, device CPU speed, device CPU temperature, device memory usage, and device swap size, among others. In some embodiments, one or more agents and/or internal servers are used to collect the metrics. For example, a user agent can be installed on an infrastructure device to collect operating and/or configuration data of the device and/or internal servers can be used to collect network metrics and/or function as relays to the different deployed device user agents. The internal servers can then relay the collected metrics to the anomaly detection service.

At 305, an anomaly is predicted. For example, anomalies are predicted by applying the metrics collected via the monitoring performed at 303 to one or more trained machine learning models. In some embodiments, potential anomalies are first detected by applying an inference process using an unsupervised machine learning model. Once a supervised machine learning model can be trained, the output of the unsupervised machine learning model is further refined by feeding its prediction results to the trained supervised machine learning model such as a supervised machine learning anomaly classifier. In some embodiments, the supervised machine learning model functions as an expert sub-model. In various embodiments, the anomaly prediction results are provided to the users as anomaly notifications such as via an interactive user interface dashboard.

In various embodiments, although the output of the unsupervised machine learning model is fed as input to a supervised machine learning model, in the initial use or startup cases, the supervised machine learning model may be a default or trivial model that simply outputs the prediction results of the unsupervised machine learning model without change. As additional user feedback is collected and used to train (and subsequently retrain as even more user feedback is collected), the prediction results of the supervised machine learning model will begin to deviate from the results of the unsupervised machine learning model. For example, the anomaly classification results of the supervised machine learning model will be superior and more accurate than the results from the unsupervised machine learning model alone. In various embodiments, a minimum amount of user feedback is required to retrain the supervised machine learning model. In some alternative embodiments, the supervised machine learning model is bypassed until sufficient user feedback is collected to train the supervised machine learning model. Once the supervised machine learning model is trained, the anomaly prediction results are determined using the combined trained unsupervised and supervised machine learning models.

At 307, user feedback on the predicted anomaly is received. For example, user feedback including labeling feedback is collected on anomaly prediction results. In some embodiments, the results are collected via an interactive user interface dashboard. For example, when a predicted anomaly is provided, the user can specify whether the anomaly information is helpful or not helpful such as whether the anomaly is a true or false positive. The user can further provide information on the features that should correctly and/or should not incorrectly influence the prediction result, among other feedback responses. In some embodiments, the user feedback is optional feedback and is provided via a user interface that streamlines collecting user feedback. Moreover, in various embodiments, the maturity of the anomaly detection service and its particular model or models is provided. As additional feedback is provided by users, the anomaly detection results will increase in accuracy along with the determined maturity of the anomaly detection service, its corresponding models, and in particular the supervised machine learning model. The provided maturity can be a maturity score and/or feedback score and can function as an incentive for users to provide additional feedback.

At 309, a supervised machine learning anomaly classifier is trained. For example, using the feedback received at 307, the user feedback is profiled and/or preprocessed as training data for training the supervised machine learning model. In some embodiments, the training process performed is a subsequent retraining of the model with additional and/or improved training data. As the model is retrained over time with additional user feedback, the accuracy of the model will generally improve and will result in more accurate prediction results. In various embodiments, the supervised machine learning model is a machine learning anomaly classifier that classifies the anomaly prediction results of the unsupervised machine learning model configured at 301. Along with an anomaly prediction result or classification result, the output of the supervised machine learning anomaly classifier can include an anomaly severity such as whether a predicted anomaly is a minor, major, or severe anomaly. Other measurements of the severity of a predicted anomaly such as a ranking or rating can used as well.

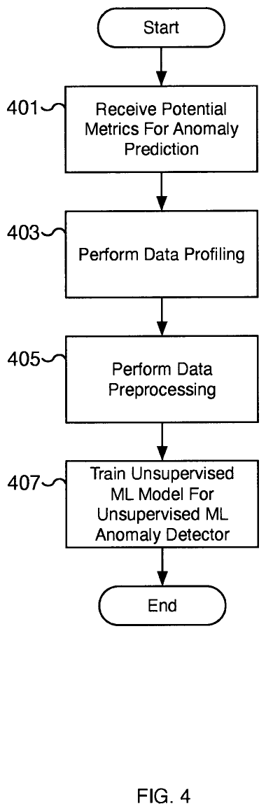

FIG. 4 is a flow chart illustrating an embodiment of a process for configuring and training an unsupervised machine learning anomaly detector. For example, using the process of FIG. 4, an unsupervised machine learning model used by an anomaly detection service can be trained to predict anomalies within an IT infrastructure environment. In various embodiments, the model is also trained to reconstruct its provided input. The reconstructed input can be provided along with prediction results to a supervised machine learning model to classify the prediction results of the unsupervised machine learning anomaly detector. In some embodiments, the process of FIG. 4 is performed at 301 of FIG. 3 by an anomaly detection service. In some embodiments, the anomaly detection service is anomaly detection service 121 of FIG. 1 and/or anomaly detection service 200 of FIG. 2, the unsupervised machine learning model is associated with unsupervised machine learning anomaly detector 207 of FIG. 2, and/or the supervised machine learning model is associated with supervised machine learning anomaly classifier 209 of FIG. 2.

At 401, potential metrics for anomaly prediction are received. For example, metrics collected by monitoring an IT infrastructure are identified and received by the anomaly detection service. In some embodiments, a specification of the metrics is received. In various embodiments, the metrics and corresponding data correspond to potential features and training data that can be potentially utilized to train the unsupervised machine learning model.

At 403, data profiling is performed. For example, the data received and/or specified at 401 is evaluated based on its determined profile. In some embodiments, the profiling step is performed to determine which types of data are likely to be useful in training the unsupervised machine learning model. For example, potential training data can be evaluated to determine whether the values associated with a particular metric are constant and/or have characteristics associated with useful training data. Metrics with constant (or stationary) values can be excluded from the training dataset. In some embodiments, the profiling step can apply one or more configured filters and/or checks to evaluate a metric to determine whether the metric will be a useful feature to train on. Data that meets the profile for useful training data can be passed to preprocessing step 405. In some embodiments, the data profiling is performed by data profiling module 203 of FIG. 2.

At 405, data preprocessing is performed. For example, the data identified as potential useful training data based on its profile is preprocessed to prepare the data as training data. In some embodiments, the preprocessing includes converting values between different units, normalizing values, and/or forward filling values for certain features such as in the case of missing values. In some embodiments, the preprocessing step will fill missing older values, for example, with the mean value of the metric or another appropriate value. In some embodiments, the data preprocessing is performed by preprocessing module 205 of FIG. 2.

At 407, an unsupervised machine learning model is trained for the unsupervised machine learning anomaly detector. For example, using the training data that has passed through the profiling and preprocessing steps, the prepared training data is used to train a machine learning model for the unsupervised machine learning anomaly detector. In various embodiments, due to the large number of input features and the corresponding large amount of input feature data, unsupervised training techniques are applied to train the model. For example, the number of features for the unsupervised machine learning model can exceed tens, dozens, or hundreds of features. In some embodiments, the trained unsupervised machine learning model includes an auto-encoder that learns the feature data and allows the trained unsupervised machine learning model to reconstruct the input data it is provided. In some embodiments, the unsupervised machine learning model is trained by training module 217 of FIG. 2.

In various embodiments, the unsupervised training performed at 407 includes determining one or more threshold values. For example, a trained unsupervised machine learning model can include an identified threshold value required to trigger a predicted anomaly. In some embodiments, the unsupervised machine learning model is trained to predict an anomaly score and the determined threshold value corresponds to the minimum predicted anomaly score required to infer a predicted anomaly. In some embodiments, the model is further configured with one or more configurations and/or operating values. For example, the unsupervised machine learning model can be configured to predict an expected number of anomalies for a specified time period. In the event the predicted number of anomalies is outside the configured expected range (e.g., either less than or greater than), the model may be selected for retraining in order to conform to the configured operating parameters.

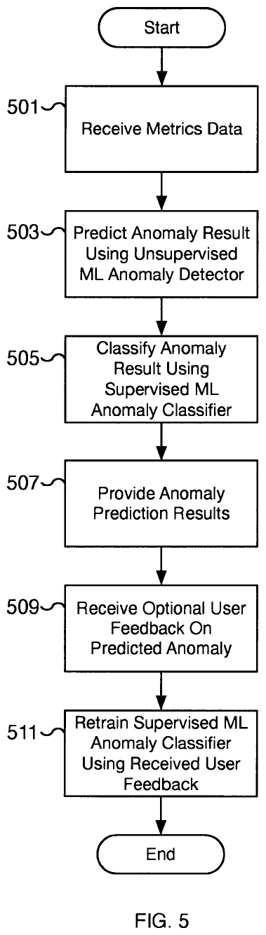

FIG. 5 is a flow chart illustrating an embodiment of a process for detecting an anomaly using a combined unsupervised machine learning model and a supervised machine learning model. For example, using the process of FIG. 5, an anomaly detection service can predict anomalies by utilizing a supervised machine learning anomaly classifier to classify prediction results of an unsupervised machine learning anomaly detector. Moreover, the classifier can be improved by collecting user feedback on the anomality classification results. In some embodiments, the process of FIG. 5 is performed at 305, 307, and/or 309 of FIG. 3 by an anomaly detection service. In some embodiments, the anomaly detection service is anomaly detection service 121 of FIG. 1 and/or anomaly detection service 200 of FIG. 2, the unsupervised machine learning model is associated with unsupervised machine learning anomaly detector 207 of FIG. 2, and/or the supervised machine learning model is associated with supervised machine learning anomaly classifier 209 of FIG. 2.

At 501, metrics data is received. For example, metrics data collected by monitoring an IT infrastructure is received. The monitored data can be collected in real time and provided to the anomaly detection service. In various embodiments, the metrics correspond to configuration and/or operating data of the IT infrastructure and its devices. Example metrics data that can be collected and received at 501 includes but is not limited to metrics related to network utilization, the number of incoming packets per second, the number of outgoing packets per second, device CPU speeds, device CPU temperatures, device memory usages, device swap sizes, and the number of running processes, among others. In various embodiments, the metrics data corresponds to the input features utilized for predicting anomaly results. In some embodiments, the received metrics data can be preprocessed prior to using the data for inference. For example, missing values, values resulting from misconfiguration, and/or any other values that correspond to improperly collected metrics may be addressed by preprocessing the metrics data.

At 503, an anomaly result is predicted using an unsupervised machine learning anomaly detector. For example, the metrics data received at 501 is used as input feature data for predicting an anomaly. An example predicted anomaly can correspond to an expected application failure associated with a surge in swap memory size, limited free memory, and local storage space running low for a server. In various embodiments, the machine learning prediction uses a trained unsupervised machine learning model. The machine learning model can also reconstruct the provided input and include the reconstructed input along with a predicted anomaly result. In some embodiments, the reconstructed input outputted by the unsupervised machine learning anomaly detector corresponds to the input used to infer the predicted anomaly result.

At 505, the anomaly result is classified using a supervised machine learning anomaly classifier. For example, the anomaly result predicted by the unsupervised machine learning anomaly detector at 503 is applied as an input to a supervised machine learning anomaly classifier. The supervised machine learning anomaly classifier classifies the anomaly to determine a classified anomaly result. In various embodiments, the supervised machine learning anomaly classifier utilizes a trained supervised machine learning model. Along with the prediction result of the unsupervised machine learning anomaly detector, the supervised machine learning anomaly classifier can also receive as input the corresponding input used by the unsupervised machine learning anomaly detector. In some embodiments, the input data received by the supervised machine learning anomaly classifier is a reconstructed version of the input. In various embodiments, the supervised machine learning anomaly classifier functions as an expert sub-model to improve the anomaly results by applying a second machine model that is a trained supervised machine learning model. The supervised machine learning model used by the supervised machine learning anomaly classifier can be trained with feedback provided from users based on previous anomaly prediction results. The classified anomaly result can correspond to one or multiple anomaly prediction result values including no anomaly, a minor anomaly, a severe anomaly, and/or a critical anomaly, among others. Other rankings, scales, and/or measurements for an anomaly can be utilized for a classified anomaly result as well.

At 507, anomaly prediction results are provided. For example, the results from the anomaly classification performed by the supervised machine learning anomaly classifier at 507 are provided to a user. In some embodiments, the results can correspond exactly to the results of the unsupervised machine learning anomaly detector prediction at 503, such as when the supervised machine learning anomaly classifier applied at 505 has not been trained with sufficient user feedback. In various embodiments, the results can be provided to the user via an interactive user interface dashboard. The provided results can include the metrics that contributed to the results (such as which metrics likely resulting in a detected anomaly) and/or the current maturity and/or change in maturity of the model(s). In various embodiments, the results are provided to a client that can access the results from the anomaly detection service via a network application such as a web browser.

At 509, optional user feedback is received on the predicted anomaly. For example, the user can provide feedback on the anomaly prediction results provided at 507. In various embodiments, the feedback can be received via an interactive user interface dashboard. For example, a user can specify that the anomaly results are not useful or are useful via a user dialog. In some embodiments, users can rank the usefulness of the results. In some embodiments, users can specify whether a predicted anomaly is a true positive or a false positive and/or provide a severity score for a predicted anomaly. For example, in various embodiments, a user can specify that a predicted anomaly is not an anomaly, is a minor anomaly, is a severe anomaly, or is a critical anomaly.

In various embodiments, a user can provide additional feedback on the metrics impacting the anomaly prediction results. For example, a user can specify that a metric should or should not be considered and/or how heavily the metric should have been considered. In some embodiments, the user can provide responses in a natural language format and/or select responses from prepopulated options. In various embodiments, the provided user feedback is optional feedback and is used to retrain the supervised machine learning model used by the supervised machine learning anomaly classifier.

At 511, the supervised machine learning anomaly classifier is retrained using the received user feedback. For example, the user feedback received at 509 is used to retrain the supervised machine learning model used by the supervised machine learning anomaly classifier. In some embodiments, the user feedback is preprocessed, for example, as label data, for supervised training of the machine learning model. The supervised machine learning model can be rapidly retrained and can be retrained frequently, such as daily. Other intervals (or triggers) for training can be more or less frequent but in general the supervised machine learning model will be trained more frequently than the unsupervised machine learning model used by the unsupervised machine learning anomaly detector at 503. In some embodiments, the result from retraining is measured, for example, by one or more loss calculations. The retraining measurements can be used to determine a maturity for the model (such as a maturity and/or feedback score) and/or to provide feedback to quantify the amount the supervised model has improved as a result of user provided feedback.

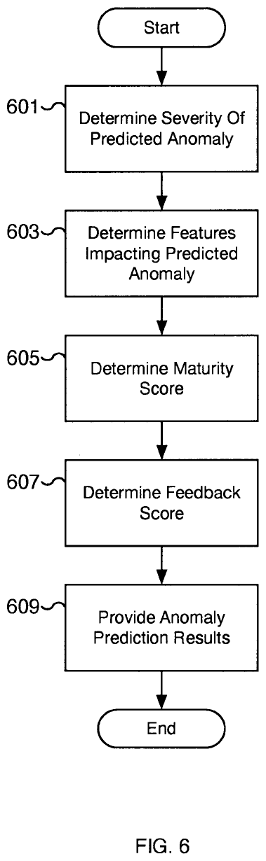

FIG. 6 is a flow chart illustrating an embodiment of a process for providing anomaly detection results using a combined unsupervised machine learning model and a supervised machine learning model. For example, using the process of FIG. 6, an anomaly detection service can provide anomaly prediction results and associated data to encourage users to submit optional feedback on the results. The collected feedback can be used to retrain the supervised machine learning model used for the anomaly detection process in order to improve the detection of future anomalies. In some embodiments, the process of FIG. 6 is performed at 305 of FIG. 3 and/or at 503, 505, and/or 507 of FIG. 5 by an anomaly detection service. In some embodiments, the anomaly detection service is anomaly detection service 121 of FIG. 1 and/or anomaly detection service 200 of FIG. 2, the unsupervised machine learning model is associated with unsupervised machine learning anomaly detector 207 of FIG. 2, and/or the supervised machine learning model is associated with supervised machine learning anomaly classifier 209 of FIG. 2.

At 601, the severity of the predicted anomaly is determined. In various embodiments, the severity of a predicted anomaly is determined based on a classification result by performing inference using a supervised machine learning anomaly classifier. For example, based on a classification result from applying a supervised machine learning model to the prediction result of an unsupervised machine learning model, the predicted anomaly is classified and mapped to one of multiple severities. In some embodiments, the severity is a discrete value that is mapped to descriptions such as no anomaly, minor anomaly, severe anomaly, or critical anomaly. In some embodiments, the severity corresponds to a severity score such as a value between 0.0 and 1.0, a value from 0 to 10, or another appropriate range of severity values.

At 603, the features impacting the predicted anomaly are determined. For example, the metrics used to predict an anomaly are evaluated and interpreted to determine which ones impacted the anomaly prediction and by how much. For example, the input features can be assigned a percentage value out of 100% based on the percentage of impact each feature has on the anomaly prediction with the most impactful features having the highest percentages. In some embodiments, the impact that features have on the prediction results are determined by an interpretability module such as interpretability module 215 of FIG. 2. In some embodiments, only the most impactful features are tracked and provided to the user. For example, the top 8 (or top 5 or top 10) most impactful features can be tracked and provided to the user. In some embodiments, only features that meet a minimum amount of impact are tracked and provided to the user. For example, only features that impact a prediction result by a threshold value (such as 5%) are provided to the user.

At 605, a maturity score is determined. For example, the maturity of the anomaly detection service and its corresponding models are determined. In some embodiments, the maturity corresponds to the maturity of the supervised machine learning model. In some embodiments, the maturity corresponds to the maturity of the combination of the unsupervised machine learning model and supervised machine learning model. In various embodiments, the maturity can be evaluated using a maturity score. For example, one or more loss calculations can be evaluated to determine a loss calculation result for a version of a trained machine learning model. The average of the last set of loss calculations can be used as a basis for evaluating the improvement in the model between trainings. For example, a running average of loss calculation results from past epochs can be calculated and used to determine the maturity of the prediction model or models. In some embodiments, the maturity can be determined by converting a logarithmic value, such as a logarithmic loss calculation result, to a linear value.

At 607, a feedback score is determined. For example, a feedback score can be determined to further describe the maturity of the anomaly detection service. In various embodiments, the feedback score corresponds to the amount of improvement made in the supervised machine learning model by retraining the model using newly provided user feedback. For example, a model can be retrained once new user feedback is provided. A new feedback score can then be determined by evaluating the difference in maturity between past versions of the model and the newly trained model that is trained on data that includes the most recent user feedback. In various embodiments, the feedback score corresponds to improvements in loss calculation results. For example, feedback score can be presented as an improvement percentage value such as the percentage of improvement compared to a previous model. In some embodiments, the improvement is presented not as a change relative to past or current models but as a change in the maturity score relative to a completely mature model (e.g., a model with a hypothetical maturity score of 100%).

At 609, the anomaly prediction results are provided. For example, anomaly prediction results that include the severity of the anomaly, the features impacting the prediction anomaly, and maturity and feedback scores are provided to the user. In some embodiments, the prediction results and corresponding data are provided via an interactive user interface dashboard. For example, the provided features impacting the prediction anomaly can be shown in ranked order along with their corresponding contribution values and their neighboring values in time (i.e., past and future values relative to the timing of the anomaly prediction). In some embodiments, the maturity and feedback scores are provided at least in part to incentivize the user to provide additional user feedback on prediction results. For example, by showing a maturing model with a higher maturity score in response to each provided collection of user feedback, the user is encouraged to continue providing user feedback in order to continue to advance the maturity of the model. In various embodiments, as user feedback is provided, the model is retrained and the corresponding newest maturity and feedback scores associated with the recently provided user feedback are determined and provided.

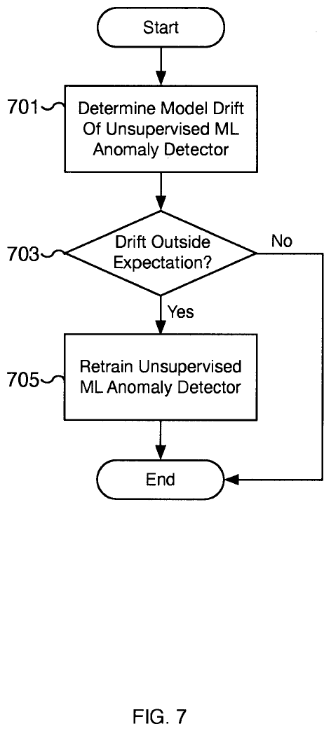

FIG. 7 is a flow chart illustrating an embodiment of a process for initiating the retraining of a machine learning model. For example, using the process of FIG. 7, one or more machine learning models used by an anomaly detection service can be retrained when their predicted results are no longer consistent with their configured expected results. For example, when the drift experienced by a model exceeds a configured threshold, the model can be provided with new configuration expectations and retrained. In some embodiments, the process of FIG. 7 is performed in parallel to the anomaly detection process at configured times and/or intervals and/or on demand. For example, a trained unsupervised machine learning model can be reevaluated for concept drift once a day, week, month, at another set time interval, and/or at request. Although the process of FIG. 7 is described with respect to trained unsupervised machine learning models, the process can also apply to trained supervised machine learning models. In some embodiments, the anomaly detection service is anomaly detection service 121 of FIG. 1 and/or anomaly detection service 200 of FIG. 2. In some embodiments, the models that may require retraining include an unsupervised machine learning model associated with unsupervised machine learning anomaly detector 207 of FIG. 2 and/or a supervised machine learning model associated with supervised machine learning anomaly classifier 209 of FIG. 2.

At 701, the model drift of the unsupervised machine learning anomaly detector is determined. For example, the anomaly detection service can be evaluated to determine the amount of concept drift associated with its models and in particular with the unsupervised machine learning model used by the unsupervised machine learning anomaly detector. In various embodiments, the model drift can be evaluated using one or more different determined metrics (each with a potential different corresponding threshold value). Model drift can be associated with changes in the operation or behavior of the anomaly detection service. For example, factors such as the number of active users, the purpose of one or more devices, and/or the distribution of the data, among other factors, may change over time and can impact prediction performance. By evaluating the model(s) for concept drift, the anomaly detection service can recalibrate one or more models to align with their configured and/or expected usage.

In some embodiments, the concept drift is associated with a change in the behavior of the unsupervised machine learning model, such as the inability for the unsupervised machine learning model to reconstruct its input for use with the supervised machine learning model. In various embodiments, concept drift is associated with model predictions that no longer meet expectations such as sensitivity and/or threshold configurations. For example, the anomaly detection service can be configured to detect a certain number of anomalies for a given time period. Over time, the service may exceed or fall short of the expected number of detected anomalies.

At 703, a determination is made whether the determined concept drift metrics are outside expected threshold values. For example, the determined concept drift metrics can exceed or fall short of one or more configured threshold values indicating the models and in particular the unsupervised machine learning model has drifted outside it's intended and desired concept goals. In the event the concept drift determined for the unsupervised machine learning anomaly detector is outside configured threshold values, processing proceeds to step 705 where the corresponding unsupervised machine learning model is retrained. In the event the concept drift determined for the unsupervised machine learning anomaly detector is within configured threshold values, processing completes and no retraining is required. In some embodiments, the identification of a single concept drift metric outside its threshold value can trigger retraining at 705. In some embodiments, every concept drift metric must be outside its corresponding threshold value to trigger retraining at 705.

At 705, the unsupervised machine learning model is retrained. For example, the unsupervised machine learning model used by the unsupervised machine learning anomaly detector is retrained and/or recalibrated. In various embodiments, the retraining and/or recalibration is based on configured sensitivity and/or threshold values. In some embodiments, the retraining may utilize the existing model and only newly collected data, such as data within a new data collection window, is used for retraining. In various embodiments, the retraining may further apply different weight to different types of data, such as applying greater weight to more recent data. Once the unsupervised machine learning model is retrained, it can be deployed for use with the unsupervised machine learning anomaly detector.

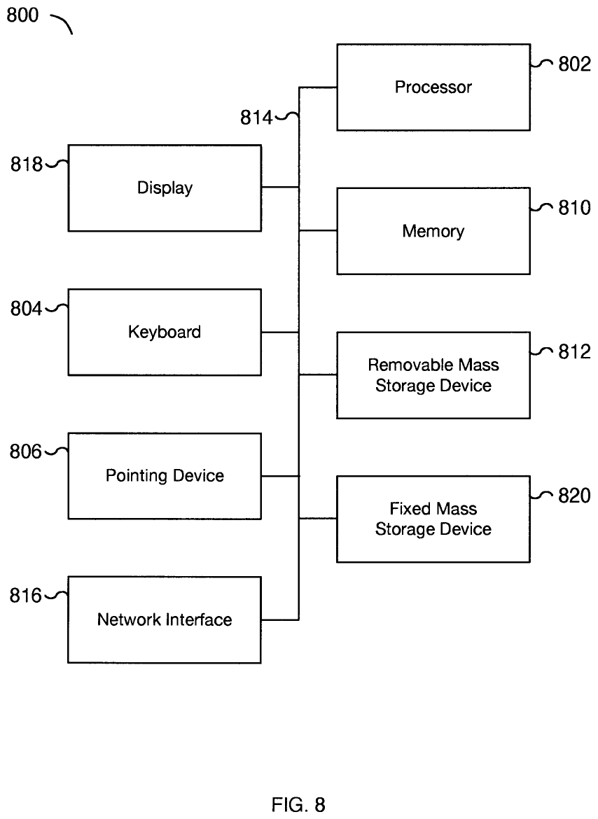

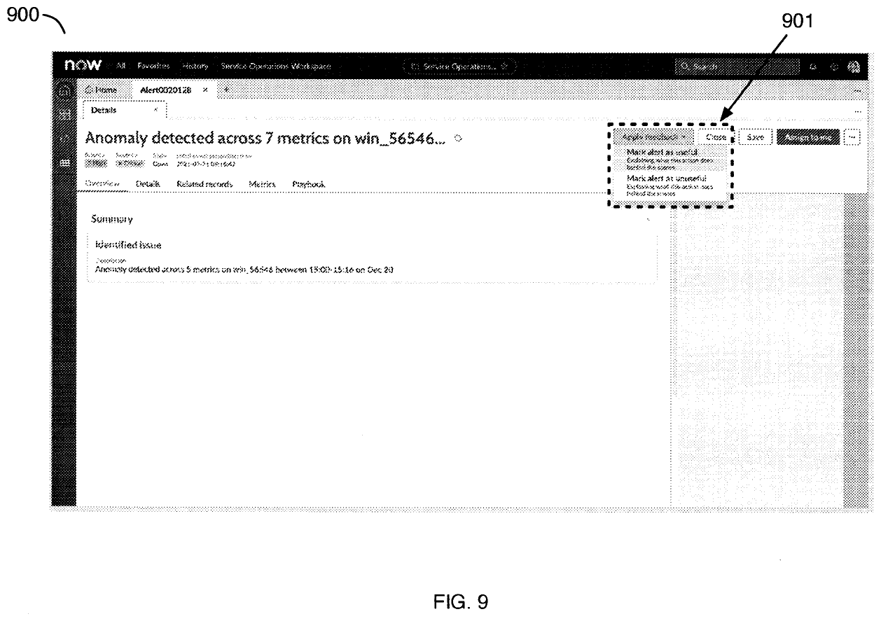

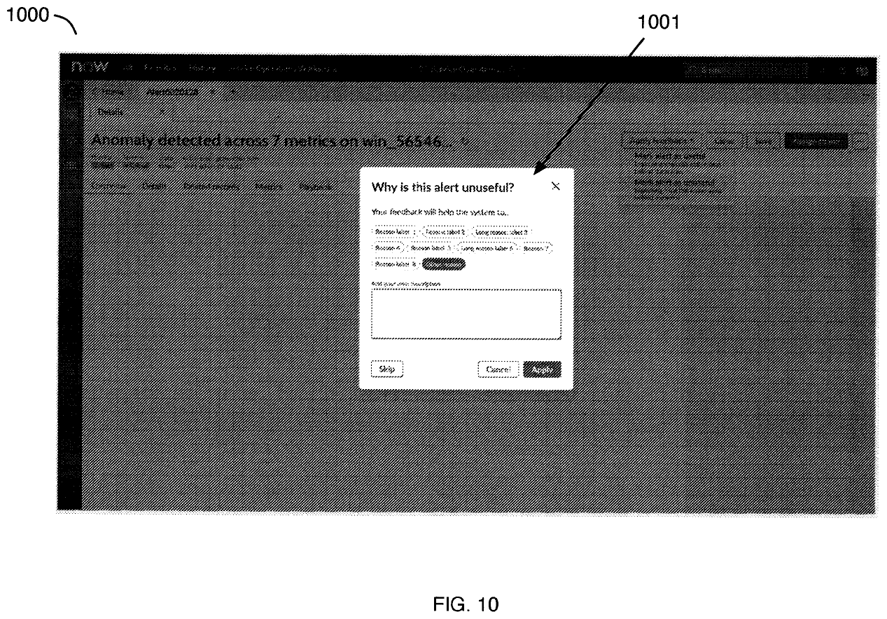

FIG. 8 is a functional diagram illustrating a programmed computer system for improving anomaly detection. As will be apparent, other computer system architectures and configurations can be utilized for performing improved anomaly detection including those with one or more graphical processing units (GPUs). Examples of computer system 800 include client 101 of FIG. 1, one or more computers of anomaly detection service 121 of FIG. 1, one or more devices of customer network environment 111 of FIG. 1, one or more computers of anomaly detection service 200 of FIG. 2, one or more computers of anomaly detection application server 201 of FIG. 2, and/or one or more computers of data store 221 of FIG. 2. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 3-7 and one or more user interfaces of FIGS. 9-10.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

FIG. 9 is a diagram illustrating an embodiment of a user interface of an anomaly detection service for collecting user feedback to improve anomaly detection. In the example shown, user interface 900 is a user interface view of an anomaly detection service that allows users to provide feedback on a detected anomaly. In various embodiments, user interface 900 is part of an anomaly detection service dashboard and displays user interface components to notify a user of a detected anomaly and to collect feedback on the detected anomaly for training (or retraining) a supervised machine learning model using the processes of FIGS. 3-7. In the example shown, user interface 900 includes user feedback dialog 901. In some embodiments, user interface 900 is provided by an anomaly detection service such as anomaly detection service 121 of FIG. 1 and/or anomaly detection service 200 of FIG. 2. In some embodiments, user interface 900 and user feedback dialog 901 are accessed by a client such as client 101 of FIG. 1 to provide feedback on predictions for a machine learning model such as an unsupervised machine learning model associated with unsupervised machine learning anomaly detector 207 of FIG. 2 and/or a supervised machine learning model associated with supervised machine learning anomaly classifier 209 of FIG. 2.

In the example shown, user interface 900 presents a detected anomaly as detected by an anomaly detection service. For example, the detected anomaly is detected for a specific device (i.e., “win_56546”) based on specific metrics (in this case 7 metrics). In various embodiments, the time and date of the detected anomaly is also shown. The anomaly detection service also displays in user interface 900 a priority level (i.e., “2-High”) and a severity (i.e., “Critical”). In the example of FIG. 9, user interface 900 shows the “Overview” pane associated with the predicted anomaly and additional panes or tabs are accessible to show additional information including additional details such as the relevant metrics associated with the detected anomaly and their corresponding values. Based on the detected anomaly shown in user interface 900, a user can utilize user feedback dialog 901 to “Apply feedback” on the anomaly including whether the anomaly alert is “useful” or “unuseful.” In the example shown, user feedback dialog 901 includes two selection options corresponding to an alert that is helpful (i.e., labeled as “Mark alert as useful”) and an alert that is not helpful (i.e., labeled as “Mark alert as unuseful”). The two options are presented along with a short description describing each option. In various embodiments, once a selection is made among the choices of user feedback dialog 901, the user can provide additional feedback on the reason behind the user's selection. In some embodiments, the user interface for the additional feedback is shown in FIG. 10. In various embodiments, the feedback provided including the selection of the detected anomaly as useful or unuseful is used to train a supervised machine learning model for use by a supervised machine learning anomaly classifier.

FIG. 10 is a diagram illustrating an embodiment of a user interface of an anomaly detection service for collecting additional user feedback to improve anomaly detection. In the example shown, user interface 1000 is a user interface view of an anomaly detection service that allows users to provide feedback on a detected anomaly including reasons for why an anomaly is not helpful. In various embodiments, user interface 1000 is part of an anomaly detection service dashboard and displays user interface components to notify a user of a detected anomaly and to collect additional feedback on the detected anomaly for training (or retraining) a supervised machine learning model using the processes of FIGS. 3-7. In the example shown, user interface 1000 includes additional user feedback dialog 1001. In some embodiments, user interface 1000 is provided by an anomaly detection service such as anomaly detection service 121 of FIG. 1 and/or anomaly detection service 200 of FIG. 2 in response to an initial selection that the detected anomaly is not useful. A similar corresponding user interface can be presented in response to an initial selection that the detected anomaly is useful. In some embodiments, the previous user interface dialog for providing the initial response is user interface 900 of FIG. 9 and in particular user feedback dialog 901 of FIG. 9. In some embodiments, user interface 1000 and additional user feedback dialog 1001 are accessed by a client such as client 101 of FIG. 1 to provide additional feedback on predictions for a machine learning model such as an unsupervised machine learning model associated with unsupervised machine learning anomaly detector 207 of FIG. 2 and/or a supervised machine learning model associated with supervised machine learning anomaly classifier 209 of FIG. 2.

In the example shown, user interface 1000 presents a dialog to solicit additional feedback once a user has provided an initial feedback response to whether a detected anomaly is not helpful (i.e., “unuseful”). The collected additional feedback can be preprocessed and utilized by the anomaly detection service as label data for training the supervised machine learning model for use by a supervised machine learning anomaly classifier. The example user interface 1000 of FIG. 10 is just one example of a technique for collecting optional user feedback that can be used as training data. For example, using additional user feedback dialog 1001, the user can select from prepopulated reasons as well as select an optional “other reason” that allows the user to provide the user's own description. In the example shown, placeholder reasons are listed. Based on a specific detected anomaly, the reasons can be prepopulated based on the metrics identified as contributing or not contributing to the detected anomaly as well as metrics that were not identified as contributing or not contributing but that should have been identified. In some embodiments, the corresponding values of the metrics can be specified as reasons as well. In various embodiments, the received additional user feedback is associated with the prediction result, the inputs used to infer the prediction result, and/or user data such as a profile of the user providing the feedback. The various provided data can then be preprocessed and used as training data. In some embodiments, the provided data can be applied a weight to emphasize or deemphasize the provided feedback as training data. Weights can be applied based on factors such as based on the user providing the feedback, the type of anomaly detected, and/or the type of metrics referenced, etc. In some embodiments, the provided user feedback used to train and improve the accuracy of the anomaly detection services also directly influences the maturity of the machine learning models utilized. For example, as additional feedback is provided and collected, the maturity of the service improves and can be represented as a maturity and/or feedback score.

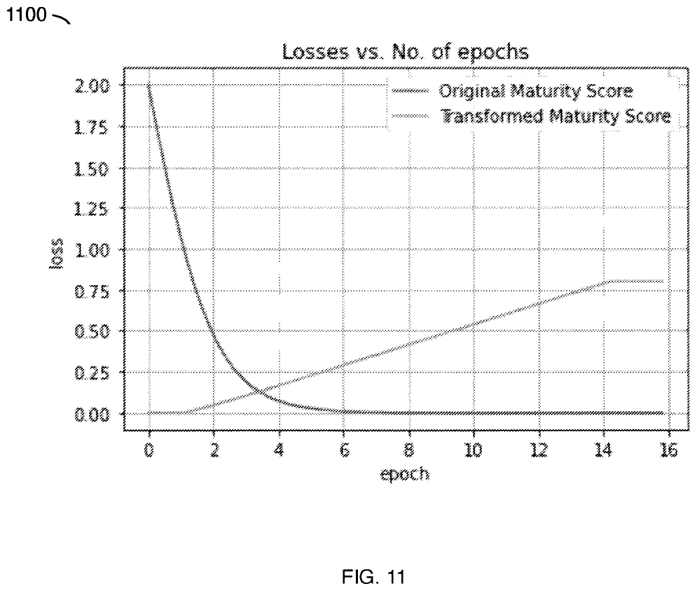

FIG. 11 is a diagram illustrating an embodiment of a conversion scale used to transform an exponential maturity score to a linear maturity score. For example, a maturity score that uses an exponential scale can be determined based on lose calculations corresponding to one or more training epochs for a machine learning model. The maturity score using the exponential scale can then be transformed to a maturity score that uses a linear scale. In various embodiments, the linear scaled maturity score is provided to users as feedback in response to user provided training data. For example, as user provided training data is provided, the maturity score increases and approaches a maximum value (such as ˜80% “maturity”). In some embodiments, the user training data is provided as user feedback data using the processes of FIGS. 3-7 and/or user interface 900 of FIG. 9 and/or user interface 1000 of FIG. 10. As shown in the example, a maximum maturity score can be capped at a value under 100% such as at 80%. In some embodiments, the incremental maturity after a certain number of epochs tapers off so a maturity score of 100% may not be reachable. In particular embodiments, the linear scaled maturity score is used to emphasize to users the importance of providing additional training data.

In some embodiments, graph 1100 depicting the conversion scale used to transform an exponential maturity score to a linear maturity score is utilized by an anomaly detection service such as anomaly detection service 121 of FIG. 1 and/or anomaly detection service 200 of FIG. 2 in response to retraining a machine learning model. In some embodiments, the retrained machine learning model is an unsupervised machine learning model associated with unsupervised machine learning anomaly detector 207 of FIG. 2 and/or a supervised machine learning model associated with supervised machine learning anomaly classifier 209 of FIG. 2. In particular embodiments, since the maturity score can be used to promote additional user feedback to train a supervised machine learning model, the maturity score is based on the maturity of the supervised machine learning model.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving a training dataset for anomaly detection;
training an unsupervised machine learning model using at least a portion of the training dataset, to generate a trained unsupervised machine learning model;
training a supervised machine learning model using an output from the unsupervised machine learning model and an anomaly detection feedback associated with the output from the unsupervised machine learning model, to generate a trained supervised machine learning model; and
providing both the trained unsupervised machine learning model and the trained supervised machine learning model for combined use in machine learning anomaly detection inference.

2. The method of claim 1, further comprising determining and providing an indication of a maturity of the supervised machine learning model.

3. The method of claim 2, wherein determining the indication of the maturity of the supervised machine learning model includes performing a loss calculation.

4. The method of claim 2, wherein the indication of the maturity of the supervised machine learning model is associated with a maturity score, and the maturity score is based on loss calculation results for three or more epochs associated with the supervised machine learning model.

5. The method of claim 2, wherein determining the indication of the maturity includes converting a logarithmic value to a linear value.

6. The method of claim 1, wherein the anomaly detection feedback includes one or more features identified by a user as contributing to a predicted anomaly.

7. The method of claim 1, wherein the supervised machine learning model is trained at a first training rate that is greater than a second training rate at which the unsupervised machine learning model is trained.

8. The method of claim 1, further comprising detecting an anomaly by performing a machine learning anomaly detection inference process, wherein a prediction output of the trained unsupervised machine learning model is provided as an input to the trained supervised machine learning model.

9. The method of claim 1, wherein the unsupervised machine learning model is trained to reconstruct an input provided to the unsupervised machine learning model, and the unsupervised machine learning model provides the reconstructed input as an input to the trained supervised machine learning model.

10. The method of claim 1, wherein the supervised machine learning model is further trained to predict a severity score of a predicted anomaly.

11. The method of claim 1, further comprising determining and providing an indication of a feedback score corresponding to an improvement attributed to the anomaly detection feedback in predicting an anomaly compared to a previous version of the combined trained unsupervised machine learning model and trained supervised machine learning model.

12. A system comprising:
one or more processors; and
a memory coupled to the one or more processors, wherein the memory is configured to provide the one or more processors with instructions which when executed cause the one or more processors to:
receive a training dataset for anomaly detection;
train an unsupervised machine learning model using at least a portion of the training dataset, to generate a trained unsupervised machine learning model;
train a supervised machine learning model using an output from the unsupervised machine learning model and an anomaly detection feedback associated with the output from the unsupervised machine learning model, to generate a trained supervised machine learning model; and
provide both the trained unsupervised machine learning model and the trained supervised machine learning model for combined use in machine learning anomaly detection inference.

13. The system of claim 12, wherein the memory is further configured to provide the one or more processors with instructions which when executed cause the one or more processors to determine and provide an indication of a maturity of the supervised machine learning model.

14. The system of claim 13, wherein the indication of the maturity of the supervised machine learning model is associated with a maturity score, and the maturity score is based on loss calculation results for three or more epochs associated with the supervised machine learning model.

15. The system of claim 13, wherein determining the indication of the maturity includes converting a logarithmic value to a linear value.

16. The system of claim 12, wherein the anomaly detection feedback includes one or more features identified by a user as contributing to a predicted anomaly.

17. The system of claim 12, wherein the supervised machine learning model is trained at a first training rate that is greater than a second training rate at which the unsupervised machine learning model is trained.

18. The system of claim 12, wherein the memory is further configured to provide the one or more processors with instructions which when executed cause the one or more processors to detect an anomaly by performing a machine learning anomaly detection inference process, wherein a prediction output of the trained unsupervised machine learning model is provided as an input to the trained supervised machine learning model.

19. The system of claim 12, wherein the unsupervised machine learning model is trained to reconstruct an input provided to the unsupervised machine learning model, and the unsupervised machine learning model provides the reconstructed input as an input to the trained supervised machine learning model.

20. A computer program product, the computer program product being embodied in a non-transitory computer readable storage medium and comprising computer instructions for:
receiving a training dataset for anomaly detection;
training an unsupervised machine learning model using at least a portion of the training dataset, to generate a trained unsupervised machine learning model;
training a supervised machine learning model using an output from the unsupervised machine learning model and an anomaly detection feedback associated with the output from the unsupervised machine learning model, to generate a trained supervised machine learning model; and
providing both the trained unsupervised machine learning model and the trained supervised machine learning model for combined use in machine learning anomaly detection inference.
